(19) United States
(12) Patent Application Publication
(10) Pub. No.: US 2019/0320267 A1
(43) Pub. Date: Oct. 17, 2019

(54) ELECTRONIC APPARATUS HAVING BUILT-IN SPEAKER

(71) Applicant: PEGATRON CORPORATION, Taipei (TW)

(72) Inventors: Yu-Hao Chiu, Taipei (TW); Tzu-Ming Yang, Taipei (TW)

(21) Appl. No.: 16/250,016

(22) Filed: Jan. 17, 2019

(30) Foreign Application Priority Data
Apr. 13, 2018 (TW) 107112804

(51) Int. Cl. H04R 17/00; H04R 1/02

(52) U.S. Cl. CPC H04R 17/00; H04R 2499/11; H04R 1/025

(57) ABSTRACT

An electronic apparatus includes a main body, an upper cover, and a pair of piezoelectric speaker units. The main body has a signal generator, and the signal generator provides a voltage signal. The upper cover is rotatably connected to the main body, to be opened or overlapped relative to the main body. The pair of piezoelectric speaker units are disposed at two opposite sides of the upper cover and electrically connected to the signal generator. The pair of piezoelectric speaker units generates an audio signal by using the voltage signal provided by the signal generator.

### CROSS-REFERENCE TO RELATED APPLICATION

This non-provisional application claims priority under 35 U.S.C. § 119(a) to Patent Application No. 107112804 filed in Taiwan, R.O.C. on Apr. 13, 2018, the entire contents of which are hereby incorporated by reference.

### BACKGROUND

### Technical Field

The application relates to an electronic apparatus, and specifically, to an electronic apparatus having a built-in piezoelectric speaker.

### Related Art

Generally, a conventional notebook is provided with a group of audio speakers. Based on a system design, the speakers are generally disposed on left and right sides of a main unit and the sound holes are formed on a housing of the main unit corresponding to the speakers. Consequently, positions at which the speakers are mounted are limited, and a sound effect and the appearance of the apparatus are significantly affected.

In addition, as computer games become popular and a requirement on the sound effect is increased, because the speakers of the conventional notebook computer do not have a desired stereo degree, a user usually needs to select and purchase an accessory such as a headset or an external speaker, to enhance the stereo degree and the sound effect, resulting in inconvenience in use and a storage problem when a peripheral device is idle.

### SUMMARY

An objective of the application is to provide an electronic apparatus, and a piezoelectric speaker is built inside an upper cover of the electronic apparatus, to generate an audio signal, so that no hole needs to be formed on a housing, and the appearance is improved.

In an embodiment, an electronic apparatus of the application includes a main body, an upper cover, and a pair of piezoelectric speaker units, where the main body comprises a signal generator, and the signal generator provides a voltage signal; the upper cover is rotatably connected to the main body, to be opened or overlapped relative to the main body; the pair of piezoelectric speaker units are disposed at two opposite sides of the upper cover and electrically connected to the signal generator, and the pair of piezoelectric speaker units generate an audio signal by using the voltage signal provided by the signal generator.

In an embodiment, the pair of piezoelectric speaker units each includes a ceramic piezoelectric sheet, and the ceramic piezoelectric sheet is deformed based on the voltage signal, to generate the audio signal.

In an embodiment, the upper cover includes a first inner surface and a second inner surface opposite to each other, an accommodating space is formed between the first inner surface and the second inner surface, and the pair of piezoelectric speaker units are disposed in the accommodating space. A first gap is formed between the first inner surface and the piezoelectric speaker units, and a second gap is formed between the second inner surface and the piezoelectric speaker units.

In an embodiment, the upper cover further includes a plurality of positioning members, where the plurality of positioning members are disposed on at least one of the first inner surface or the second inner surface, and the plurality of positioning members are separately configured to position the pair of piezoelectric speaker units.

In an embodiment, the electronic apparatus of the application further includes a speaker unit, where the speaker unit is disposed at the main body and electrically connected to the signal generator, and the signal generator simultaneously drives the speaker unit and the pair of piezoelectric speaker units.

In an embodiment, the electronic apparatus of the application further includes a rotating shaft mechanism, where the upper cover is rotatably connected to the main body by using the rotating shaft mechanism, and the pair of piezoelectric speaker units are disposed at two opposite sides of the upper cover and distant from the rotating shaft mechanism.

Compared with the prior art, in the electronic apparatus of the application, a piezoelectric speaker unit can be built inside the upper cover, so that the upper cover is used as a sound box of the piezoelectric speaker unit, no sound hole needs to be formed, and an appearance design of a product is not damaged.

### BRIEF DESCRIPTION OF THE DRAWINGS

FIG. 1A and FIG. 1B are schematic diagrams of an electronic apparatus from different visual angles according to an embodiment of the application;

FIG. 2A is a schematic diagram of a piezoelectric speaker unit according to an embodiment of the application;

FIG. 2B and FIG. 2C are action schematic diagrams of the piezoelectric speaker unit in FIG. 2A;

FIG. 3 is a schematic partial side view of an electronic apparatus according to an embodiment of the application;

FIG. 4A and FIG. 4B are schematic diagrams of positioning of a piezoelectric speaker unit according to different embodiments of the application;

FIG. 5A is a schematic diagram of an electronic apparatus according to another embodiment of the application; and

FIG. 5B is a locally enlarged diagram of FIG. 5A.

### DETAIL DESCRIPTION OF THE EMBODIMENTS

The application provides an electronic apparatus and particularly an electronic apparatus having a built-in piezoelectric speaker, to improve the appearance of the apparatus, increase flexibility of a location at which the speaker is mounted, or improve sound performance, to achieve a stereo surround sound. In embodiments of the application, the electronic apparatus is preferably an information processing apparatus such as a notebook computer, and includes an upper cover and a main body. The upper cover and the main body can be in an opened state or an overlapped state relative to each other, so that a piezoelectric speaker unit is built inside the upper cover, but is not limited thereto. The following describes the embodiments of the electronic apparatus of the application in detail with reference with the accompanying drawings.

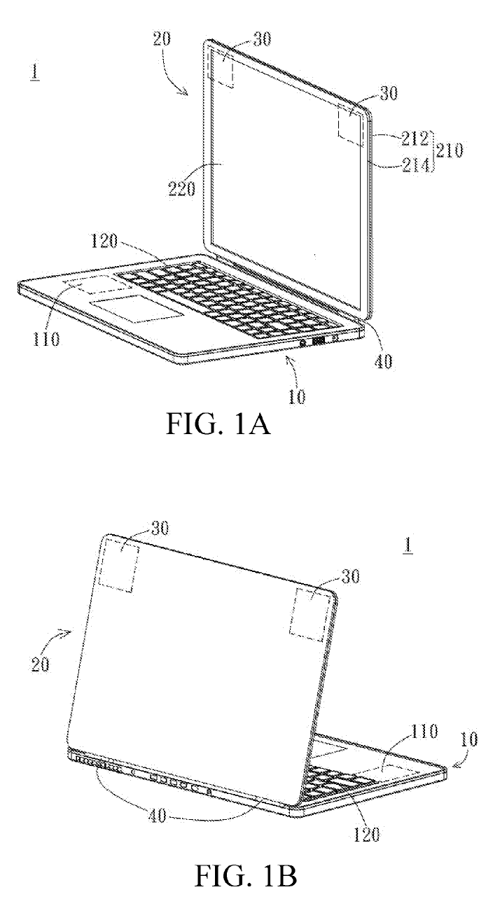

As shown in FIG. 1A and FIG. 1B, in an embodiment, an electronic apparatus 1 of the application includes a main body 10, an upper cover 20, and a pair of piezoelectric speaker units 30. The upper cover 20 is rotatably connected to the main body 10, to be opened or overlapped relative to the main body 10. The main body 10 includes a signal generator 110, and the signal generator 110 may provide a voltage signal. The pair of piezoelectric speaker units 30 are preferably disposed at two opposite sides of the upper cover 20 and electrically connected to the signal generator 110. The pair of piezoelectric speaker units 30 generate an audio signal by using the voltage signal provided by the signal generator 110.

In an embodiment, the electronic apparatus 1 is preferably a notebook computer. The main body 10 may be a computer body combining various elements that enable the electronic apparatus to perform required computer functions such as control, processing, and input. That is, the main body 10 may be a system body of the notebook computer, but is not limited thereto. The signal generator 110 may be, for example, a circuit element (for example, a sound card) in the computer body that may provide an electrical signal to a sounding apparatus (for example, a speaker), to drive the sounding apparatus to generate the audio signal, but is not limited thereto.

The upper cover 20 preferably includes any appropriate display screen, and may also be a display screen having a touch function, but is not limited thereto. For example, when the main body 10 is a computer body including a keyboard 120, the upper cover 20 may include only a display screen to display information output from the computer body. As shown in FIG. 1A, in this embodiment, the upper cover 20 includes an upper cover housing 210 and a display panel 220 disposed at the upper cover housing 210, and is used as a display of the electronic apparatus 1. The electronic apparatus 1 may further include a rotating shaft mechanism 40 connected to the upper cover 20 and the main body 10. In an embodiment, the rotating shaft mechanism 40 may be a hinge, or any appropriate pivotally-connected mechanism (for example, a combination of a rotating shaft and a shaft hole), but is not limited thereto. The upper cover 20 is pivotally connected to one side of the main body 10 by using the rotating shaft mechanism 40, so that the upper cover 20 is rotatably connected to the main body 10, to be opened relative to the main body 10 in a used state, or to be overlapped with the main body 10 in a stored state.

The piezoelectric speaker unit 30 has features, for example, a relatively thin thickness, relatively low power consumption, a relatively simple structure, and easy fixation or adhesion due to an approximately flat outline, and the piezoelectric speaker unit 30 cannot cause cell interference or electromagnetic radiation due to free of a coil material. Therefore, the piezoelectric speaker unit 30 may be mounted at any appropriate position (for example, the upper cover 20) without a sound hole, thereby improving an appearance design of the electronic apparatus and mounting flexibility. In this embodiment, the pair of piezoelectric speaker units 30 are preferably disposed at left and right sides of the upper cover housing 210 separately and distant from the rotating shaft mechanism 40. That is, when the upper cover 20 is opened relative to the main body 10, the pair of piezoelectric speaker units 30 are located at an upper side relative to the main body 10. In other words, when the upper cover 20 is opened relative to the main body 10, the pair of piezoelectric speaker units 30 are preferably located at an upper left side and an upper right side of the upper cover 20 separately, to provide a better sound effect to a user. Specifically, the pair of piezoelectric speaker are preferably disposed inside the upper cover housing 210, and generate the audio signal (namely, makes a sound) by using the upper cover housing 210 as a sound box housing.

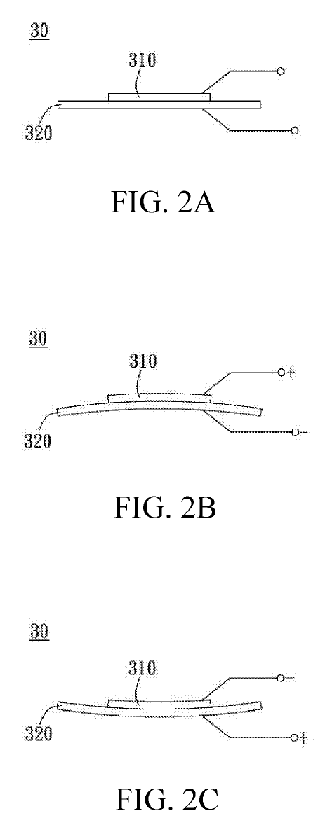

As shown in FIG. 2A, the piezoelectric speaker unit 30 includes a piezoelectric sheet 310. The piezoelectric sheet 310 may be deformed based on the voltage signal, and then forms a vibration diaphragm of the speaker, thereby generating the audio signal. In an embodiment, the piezoelectric sheet 310 of the piezoelectric speaker unit 30 is disposed on a substrate 320, to form the vibration diaphragm. In an embodiment, the substrate 320 is preferably a metal sheet, and the piezoelectric sheet 310 is preferably a ceramic piezoelectric sheet. The application is not limited thereto. Based on an actual application, the piezoelectric sheet 310 may be any appropriate piezoelectric sheet such as a monocrystal piezoelectric sheet, a polymer piezoelectric sheet, or a composite piezoelectric sheet. As shown in FIG. 2B and FIG. 2C, when the piezoelectric speaker unit 30 is driven by the voltage signal, a deformation direction and deformation of the piezoelectric sheet 310 are varied based on the voltage signal. For example, as shown in FIG. 2B, when the piezoelectric speaker unit 30 is driven by the voltage signal and enables the piezoelectric sheet 310 to extend, the vibration diaphragm is bent upward and deformed. As shown in FIG. 2C, when the piezoelectric speaker unit 30 is driven by a reverse-phase voltage signal and enables the piezoelectric sheet 320 to shrink, the vibration diaphragm is bent downward and deformed. Therefore, when the signal generator 110 provides, based on a sound source signal, a corresponding alternating-current (AC) voltage signal to the piezoelectric speaker unit 30, the vibration diaphragm including the piezoelectric sheet 310 is bent and deformed toward two opposite directions alternatively with the changes of the AC voltage signal, and in combination with a sound box function provided by the upper cover housing 210, generates an audio signal corresponding to the sound source signal.

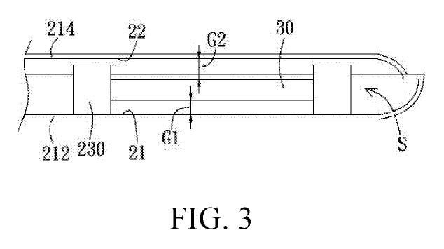

As shown in FIG. 3, the upper cover 20 includes a first inner surface 21 and a second inner surface 22 that are opposite to each other. An accommodating space S is formed between the first inner surface 21 and the second inner surface 22. The pair of piezoelectric speaker units 30 are disposed in the accommodating space S. A first gap G1 is formed between the first inner surface 21 and the piezoelectric speaker units 30, and a second gap G2 is formed between the second inner surface 22 and the piezoelectric speaker units 30. In an embodiment, the upper cover housing 210 may include a first housing 212 and a second housing 214, and the accommodating space S is formed between the first housing 212 and the second housing 214, to accommodate a display panel 220 and the piezoelectric speaker units 30. For example, the first housing 212 may be an external housing of the upper cover 20 that is back to the main body 10, and the second housing 214 may be a frame of the upper cover 20 that is face to the main body 10. The display panel 220 corresponds to an opening of the frame, is formed between the first housing 212 and the second housing 214, and is face to the main body 10. In this architecture, the first inner surface 21 and the second inner surface 22 of the upper cover 20 may be internal surfaces of the first housing 212 and the second housing 214, respectively, and the first housing 212 and the second housing 214 are opposite to each other, but are not limited thereto.

In another embodiment, when the upper cover 20 is a narrow bezel design or a bezel-less design (that is, when the second housing 214 is a thin frame or even has no second housing), the first inner surface 21 of the upper cover 20 may be an internal surface of an external housing (that is, the first housing 212), and the second inner surface 22 may be a surface of a corresponding element of the upper cover 20 facing to the piezoelectric speaker unit 30, for example, a back surface (that is, a surface opposite to a display surface) of the display panel 220. In other words, the piezoelectric speaker units 30 preferably do not be in close contact with the internal surface of the housing or the surface of the element of the upper cover 20 and have an appropriate gap with the internal surface of the housing or the surface of the element of the upper cover 20. In this way, an appropriate vibration space may exist between the piezoelectric speaker units 30 and the upper cover 20, so that a broadcast effect of vibration of the piezoelectric speaker units 30 is increased. For example, when a total thickness of the housing of the upper cover 20 may be 5.7 mm, the piezoelectric speaker units 30 preferably have a distance of approximately 1 mm from the first inner surface 21, and have a distance of approximately 1.3 mm from the second inner surface 22. In other words, the first gap G1 and the second gap G2 may be respectively 1 mm and 1.3 mm, but are not limited thereto. Values of the first gap G1 and the second gap G2 may be adjusted based on an actual application.

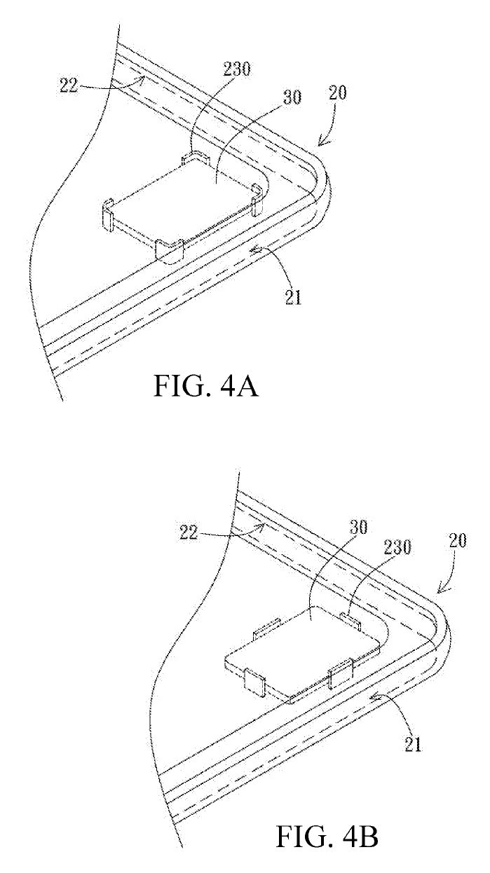

As shown in FIG. 4A and FIG. 4B, in an embodiment, the upper cover 20 includes a plurality of positioning members 230. The plurality of positioning members 230 may be disposed at at least one of the first inner surface 21 or the second inner surface 22, to separately position the pair of piezoelectric speaker units 30. In other words, based on an actual application, the positioning members 230 may be disposed on the first housing 212, or on the second housing 214, or on both the first housing 212 and the second housing 214, to position the piezoelectric speaker units 30. For example, the positioning members 230 may be such as positioning rods protruding from the first inner surface 21, and the positioning rods are correspondingly disposed at corners of or around the piezoelectric speaker unit 30, to achieve a positioning effect by means of local positioning while reducing a contact area with the piezoelectric speaker unit 30, thereby enhancing vibration of the piezoelectric speaker unit 30. However, the application is not limited thereto. In other embodiments (not shown), the piezoelectric speaker units 30 may be fixed on the first inner surface 21 or the second inner surface 22 by using a method such as locking or adhesion, and are not limited to the local positioning. For example, a frame-shaped positioning member may be used to surround an outer periphery of the piezoelectric speaker unit 30, to achieve a positioning effect.

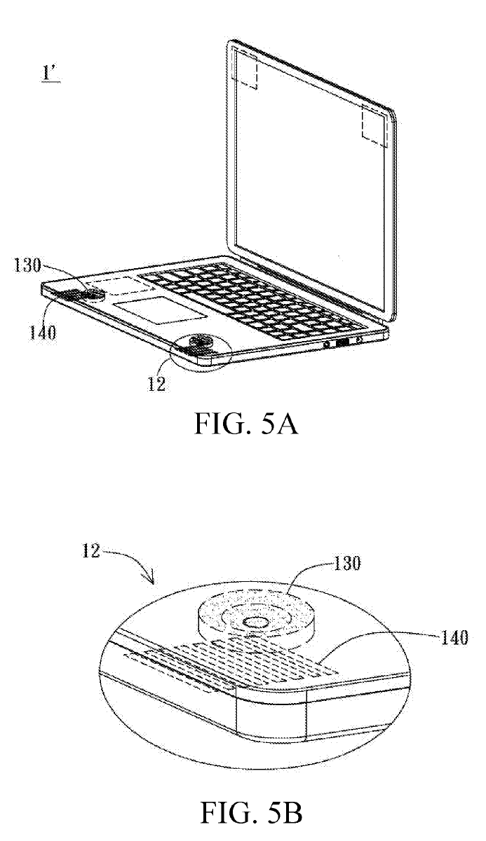

In addition, the piezoelectric speaker unit built inside the upper cover of the application may further be integrated with a speaker unit of the computer body, to provide a more stereo surround sound effect. Referring to FIG. 5A and FIG. 5B, FIG. 5A is a schematic diagram of an electronic apparatus 1′ according to another embodiment of the application, and FIG. 5B is a locally enlarged diagram of a region 12 of FIG. 5A. As shown in FIG. 5A and FIG. 5B, a difference between the electronic apparatus 1′ of FIG. 5A and the electronic apparatus 1 of FIG. 1A is that: the electronic apparatus 1′ further includes another pair of speaker units 130. The speaker units 130 are preferably disposed at a main body 10 and electrically connected to a signal generator 110. In an embodiment, the speaker units 130 are preferably coil speaker units and are disposed at left and right sides of a housing of the main body 10 in a paired manner, and sound holes 140 are preferably formed on the main body 10, to improve a sound effect of the coil speaker unit 130. In other words, in the electronic apparatus 1′ of the application, the piezoelectric speaker units 30 built inside an upper cover 20 may be integrated with an original speaker configuration of a computer, to improve sound effect performance. However, the application is not limited thereto. In another embodiment, the speaker units 130 may be piezoelectric speaker units, and have a structure similar to that of the plurality of the piezoelectric speaker units 30 in FIG. 2A. That is, in the electronic apparatus 1′ of the application, a plurality of piezoelectric speaker units 30 may be separately disposed at the upper cover 20 and the main body 10. The signal generator 110 may selectively drive the speaker units 130, or the pair of piezoelectric speaker units 30, or simultaneously drive the speaker units 130 and the pair of piezoelectric speaker units 30 based on an actual application, to generate a surround sound effect, thereby improving live experience.

In the electronic apparatuses 1 and 1′ of the application, the pair of piezoelectric speaker units 30 built inside the upper cover 20 can be combined with a sound localization technology of audio-left channel and audio-right channel of a system. When an e-sports game is played, sound from a left side or right side in the game can be identified, and a sound is given to prompt a player to make a decision, for example, a firing direction of a bullet from an enemy or a sound from a vehicle approaching to the player, to provide better immersive experience in a battle.

The application is described with reference to the foregoing embodiments, but the foregoing embodiments are merely examples and are not intended to limit the application. A person skilled in the art should know that any modification may be made to an exemplary embodiment for the embodiments particularly described herein without departing from the spirit of the application. Therefore, the application also covers such modification and is merely limited by the scope of the claims.

What is claimed is:

1. An electronic apparatus, comprising:
a main body, comprising a signal generator, wherein the signal generator provides a voltage signal;
an upper cover, rotatably connected to the main body, to be opened or overlapped relative to the main body; and
a pair of piezoelectric speaker units, disposed at two opposite sides of the upper cover and electrically connected to the signal generator, wherein the pair of piezoelectric speaker units generate an audio signal by using the voltage signal provided by the signal generator.

2. The electronic apparatus according to claim 1, wherein the pair of piezoelectric speaker units each comprises a ceramic piezoelectric sheet, and the ceramic piezoelectric sheet is deformed based on the voltage signal, to generate the audio signal.

3. The electronic apparatus according to claim 1, wherein the upper cover comprises a first inner surface and a second inner surface opposite to each other, an accommodating space is formed between the first inner surface and the second inner surface, and the pair of piezoelectric speaker units are disposed in the accommodating space, and a first gap is formed between the first inner surface and the piezoelectric speaker units and a second gap is formed between the second inner surface and the piezoelectric speaker units.

4. The electronic apparatus according to claim 3, wherein the upper cover further comprises a plurality of positioning members, the plurality of positioning members are disposed on at least one of the first inner surface or the second inner surface, and the plurality of positioning members are separately configured to position the pair of piezoelectric speaker units.

5. The electronic apparatus according to claim 1, further comprising a speaker unit, wherein the speaker unit is disposed at the main body and electrically connected to the signal generator, and the signal generator simultaneously drives the speaker unit and the pair of piezoelectric speaker units.

6. The electronic apparatus according to claim 1, further comprising a rotating shaft mechanism, wherein the upper cover is rotatably connected to the main body by using the rotating shaft mechanism, and the pair of piezoelectric speaker units are disposed at two opposite sides of the upper cover and distant from the rotating shaft mechanism.
